(19) United States
(12) Patent Application Publication
(10) Pub. No.: US 2007/0285511 A1
(43) Pub. Date: Dec. 13, 2007

(54) Video verification system and method for central station alarm monitoring

(75) Inventors: Gary Mark Shafer, Boca Raton, FL (US); Alfred Yarbrough, Loxahatchee, FL (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: ADT Security Services, Inc.

(21) Appl. No.: 11/451,800

(22) Filed: Jun. 13, 2006

(51) Int. Cl. H04N 7/18; G08B 13/00

(52) U.S. Cl. 348/143; 340/541

(57) ABSTRACT

A method, system and central monitoring station is provided for visual verification of an alarm system event in which image data corresponding to a plurality of images associated with the event is transmitted. The image data corresponding to the plurality of images is processed to create one or more processed images in which the one or more processed images are arranged to allow an operator to visually observe changes in the plurality of images. The one or more processed images are displayed.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to alarm monitoring, and in particular to a method and system for passing images to a central alarm station for visual verification of an alarm condition.

### BACKGROUND OF THE INVENTION

Typical remotely monitored alarm systems include one or more sensors at the monitored location. These sensors directly or indirectly send alarm indications to a central monitoring station where monitoring personnel takes some action based on the nature of the alarm. Such alarm indications are typically sent via modem using a standard low bandwidth telephone (POTS) line or low bandwidth cellular telephone line. However, these sensors and the entire system are susceptible to false alarms. False alarms lead to added expenses incurred with attempts to contact the location personnel, homeowner, etc., as well as the unnecessary dispatching of law enforcement or security personnel. In addition to added expenses, false alarms also decrease the efficiency of monitoring station personnel because the personnel is wasting time chasing a false alarm when they could be dealing with real alarms or other monitoring activities. A result is that the servicing of a real alarm may be delayed.

An approach to address the false alarm problem is to include a video camera to capture video associated with alarm events. These approaches typically use real time motion video that is either always being transmitted to the central monitoring station or is transmitted based on the occurrence of a sensor trigger. However, while a POTS line (or cellular telephone line) may be sufficient for conveying the trigger of an alarm to a central monitoring station, POTS lines do not provide sufficient bandwidth to allow a usable video signal to be transmitted thereon. The resultant low resolution images that can be transmitted using POTS lines are difficult to evaluate to discern whether or not an unauthorized entry to the monitored location has occurred. Further, use of higher speed transmission lines and technology adds costs and complicates the installation. Put simply, the use of video cameras to capture images for transmission to a central monitoring station is not practical without some way to allow for low resolution image evaluation.

It is therefore desirable to have a method and system that allows low resolution images to be transmitted to a central monitoring station and processed for display in a manner that allows an operator to quickly and easily discern whether the alarm is a false alarm or whether the alarm is real and requires additional processing such as the dispatch of law enforcement personnel.

### SUMMARY OF THE INVENTION

The present invention addresses the deficiencies of the art in respect to providing a visual indication to monitoring station personnel in the form of one or more images that quickly allows the operator to determine whether or not the alarm trigger is one which requires further attention. The present invention addresses the deficiencies by providing a series of low resolution images taken at period intervals in a manner that allows an operator to discern the differences from one image to the next to determine the presence of unauthorized persons and/or the absence of personnel or objects. In addition, the present invention can process the series of images to create an image that shows the differences between one or more of the images. This arrangement allows the operator's attention to be focused on the potentially relevant changes rather than have to study each image to determine if there is a difference and what that difference is.

In accordance with one aspect, the present invention provides a method for verifying an alarm system event in which image data corresponding to a plurality of images associated with the event is transmitted. The image data corresponding to the plurality of images is processed to create one or more processed images in which the one or more processed images are arranged to allow an operator to visually observe changes in the plurality of images. The one or more processed images are displayed.

In accordance with another aspect, the present invention provides a central monitoring station using image data corresponding to a plurality of images associated with an alarm event to visually verify the alarm event in which the central monitoring station has a central processing unit and a display. The central processing unit processes the image data corresponding to the plurality of images to create one or more processed images. The one or more processed images are arranged to allow an operator to visually observe changes in the plurality of images. The display displays the one or more processed images for visual verification by the operator.

In accordance with yet another aspect, the present invention provides a system for verifying an alarm system event in which the system has a camera, an alarm panel and a central monitoring station. The camera captures a plurality of images associated with the event. The alarm panel transmits image data corresponding to the plurality of images associated with the event. The central monitoring station has a central processing unit and a display. The central processing unit processes the image data corresponding to the plurality of images to create one or more processed images. The one or more processed images are arranged to allow an operator to visually observe changes in the plurality of images. The display displays the one or more processed images for visual verification by the operator.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a diagram of a system constructed in accordance with the principles of the present invention;

FIG. 2 is a diagram of an exemplary image processing procedure of the present invention;

FIGS. 3A-3C are diagrams showing exemplary images and a resultant difference image based on image processing procedures of the present invention;

FIG. 4 is a diagram of a second exemplary image processing procedure of the present invention;

FIG. 5 is a diagram of a third exemplary image processing procedure of the present invention;

FIG. 6 is a diagram of an exemplary image processing procedure of the present invention using a time delay between image acquisitions; and

FIG. 7 is a diagram of an exemplary image processing procedure of the present invention using a trigger and a time delay between image acquisitions.

### DETAILED DESCRIPTION

The present invention advantageously provides a method and system that allows an operator at a remote monitoring station to review an image or series of images to quickly distinguish between a false alarm and a real alarm. The image or images presented to the operator can be transferred from the monitored site to the central monitoring station using existing technology such as POTS lines. The images can be in the form of a series of snapshots once a triggering event has occurred or be in the form of a single composite image showing the difference between two or more images.

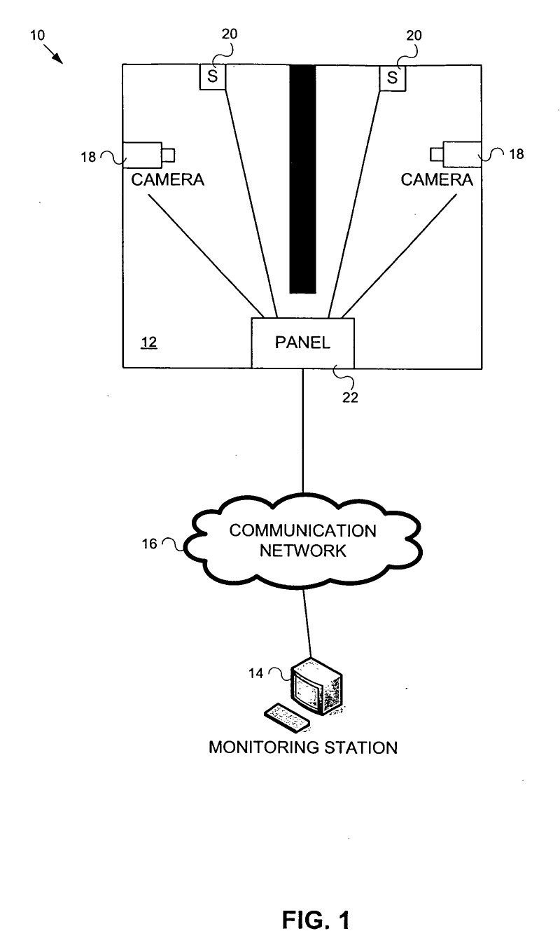

Referring now to the drawing figures in which like reference designators refer to like elements there is shown in FIG. 1 a system constructed in accordance with the principles of the present invention and designated generally as “10”. System 10 includes monitored location 12 and central monitoring station 14, communicating with one another via communication network 16. Communication network can be any communication network capable of transporting image data from monitored location 12 and central monitoring station 14, including but not limited to a POTS (dial-up network), wireless cellular telephone network, Transmission Control Protocol/Internet Protocol (“TCP/IP”) network and the like. In the case of the POTS dial-up network, the communication line connecting monitored location 12 with the elements of communication network 16 can be an analog dial-up telephone line, dedicated analog telephone line and the like.

Central monitoring station 14 is typically remotely located from monitored location 12 but need not be. Central monitoring station 14 can be coupled to communication network 16 in a similar manner as monitored location 12. Of note, it is not required that central monitoring station 14 be coupled to communication network 16 in the exact same manner as monitored location 12. For example, while monitored location 12 may be coupled to communication network 16 via a dial-up analog telephone line, the image data carried to communication network 16 on this analog line can be supplied to central monitoring station 14 via a digital communication link using a protocol such as TCP/IP. In that regard, communication network 16 includes the components needed to recover the image data from the analog line and transmit the same image data to central monitoring station 14 on a digital communication line.

Central monitoring station 14 includes hardware and software arranged to perform the functions of the present invention described herein. For example, central monitoring station 14 includes a display, central processing unit, volatile and non-volatile storage, input/output devices and a network interface for coupling central monitoring station 14 to communication network 16. The network interface can be a wired or wireless interface. Central monitoring station 14 can be any suitable computing device such as a personal computer, a mini or a mainframe computer, a personal digital assistant (“PDA”), etc. running a suitable operating system as may be known in the art. Although a single central monitoring station 14 is shown, such is done merely for the ease of explanation of the present invention. It is understood that multiple central monitoring stations 14 can be provided at a remote location in a more complex arrangement under which a pool of operators are used to monitor alarms from multiple monitored locations 12.

In operation, as is explained below in more detail, image data corresponding to an image or series of images is transmitted from monitored location 12 to central monitoring station 14 via communication network 16 upon the occurrence of a triggering event. Central monitoring station 14 processes the image data and presents one or more processed images on its display screen to the operator. This image or images allows the operator to assess whether or not the triggering event is a real alarm.

Monitored location 12 includes one more cameras 18 and sensors 20 wired or wirelessly communicating with panel 22. Sensors 20 can be any sensors capable of triggering an alarm including but not limited to wired and wireless motion sensors, heat sensors, infra-red sensors, glass break sensors, microwave sensors, acoustic sensors, ultrasonic sensors, sonic sound sensors, photoelectric sensors, pressure mats/sensors and magnetic sensors. Cameras 18 are arranged to communicate with panel 22 using wired or wireless communications. Camera 18 can be any cameras suitable for capturing images for subsequent transmission to central alarm monitoring station 14. Suitable cameras 18 include but are not limited to still or motion cameras that capture the images in black and white and/or color. Cameras 18 can be fixedly mounted or can be of the pan/tilt/zoom type. Cameras 18 can be arranged to provide continuous video or still image feeds to panel 22 or can be arranged to capture images when a sensor 20 is triggered. Cameras 18 can provide digital image data to panel 22 or can provide analog image data to panel 22. In the latter case, electronics in panel 22 digitize the analog image data for subsequent transmission to central monitoring station 14.

Panel 22 includes hardware and/or software elements for capturing digital image data from cameras 18 or, as noted above, digitizing analog image data received from cameras 18. Panel 22 also includes hardware and/or software elements for receiving trigger indications from sensors 20. Optionally, panel 22 can be arranged to trigger one or more cameras 18 to capture image data based on one or more predetermined criteria such as trigger indications from sensors 20, periodic image capture regardless of trigger event, etc. Hardware and/or software for communicating with communication network 16 are also included within panel 22. For example, panel 22 can include an analog modem for dial-up communications, a DSL modem for digital communications, a cellular phone transmitter for wireless cellular communications, etc.

In operation, panel 22 facilitates communication from monitored location 12 to central monitoring station 14 so that image data captured by cameras 18 can be processed and presented on the display of central monitoring station 14 for analysis and action by the corresponding operator.

As noted above, the image data sent to central monitoring station 14 can be based on a triggering alarm event or simply periodic images transmitted. For example, the images can be periodically captured in a continuous loop so that a pre-alarm image is captured. Regardless, it is contemplated that image data for a series of images is transmitted to central monitoring station 14 for display or subsequent processing. In the former case, the series of images can be provided within a single display window, such as in the form of thumbnail images, so that the operator can discern whether or not the images depict activity that warrants additional action at the monitored location, such as a visit by law enforcement or security personnel. In the latter case, as is described below in detail, central monitoring station 14 or some other processing device (not shown) processes the image to further simplify analysis by the operator.

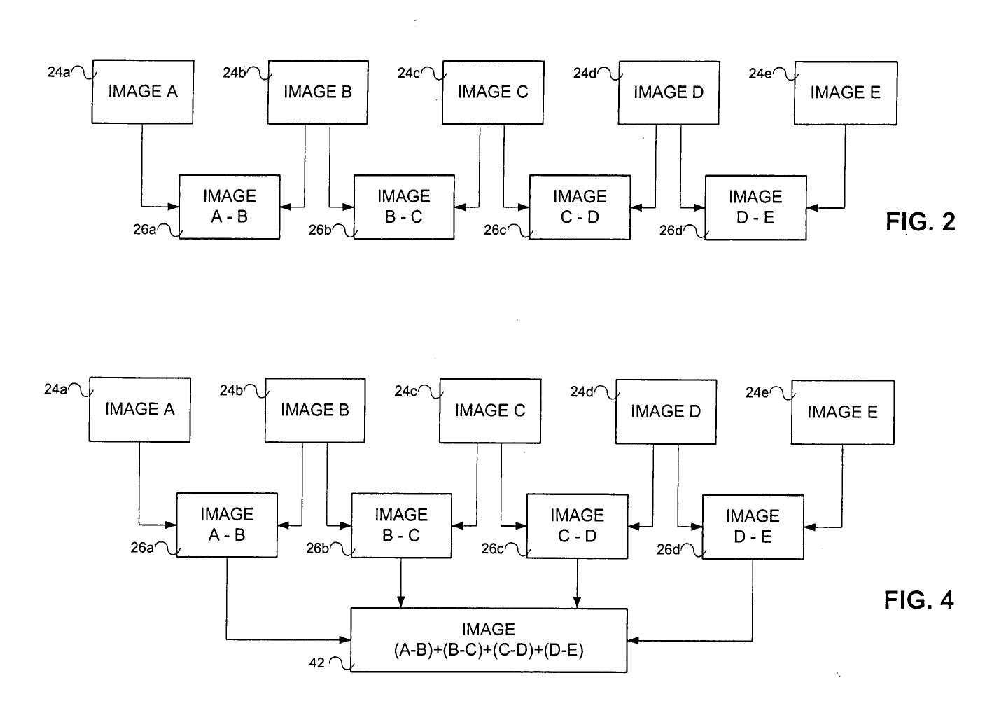

Examples of acquiring image data and processing the image data to create display images for visual verification of an alarm event are described. A first exemplary method of creating display images is described with reference to FIGS. 1 and 2. Upon occurrence of an alarm event, image data corresponding to images 24a-24e are transmitted from panel 22 to central monitoring station 14. Monitoring station 14 processes the images by subtracting the image data for each image from the image data for the previous image to create four sub-images 26a-26d. The resultant processed images 26a-26d are displayed on monitoring station 14 so that the operator can determine the absence or presence of a condition which would necessitate further action. In case of the method shown in FIG. 2, each sub-image is the difference between an image acquired by camera 18 and the previous image captured by that camera. Presenting the four processed images 26a-26d to an operator quickly allows the operator to determine whether there is something in a captured image that was not there in, or is missing from, the previous acquired image.

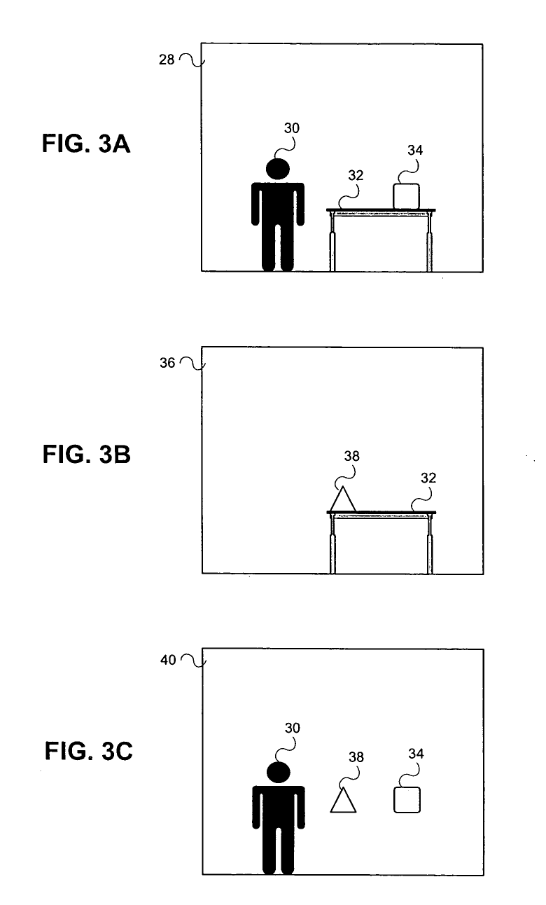

For example, FIGS. 3A, 3B and 3C show three examples of two consecutive acquired images and a processed image such as might occur with respect to the method shown in FIG. 2 or any of the other exemplary methods described herein. FIG. 3A shows frame 28 in which there is human 30, table 32 and box 34. Such an image might correspond, for example, to image 24a in FIG. 2. The next captured image, shown as frame 36 in FIG. 3B shows only the presence of table 32 and object 38. In accordance with one embodiment, frames 28 and 36 can be presented to the operator on monitoring station 14 to allow the operator to visually determine that human 30 is not present in frame 36 and that box 34 is missing. This may be significant, requiring that the operator alert security or law enforcement personnel. Frame 36 might also correspond to image 24b in FIG. 2. In such a case, monitoring station 14 would process the image data corresponding to images 24a and 24b, shown as frames 28 and 36 in FIGS. 3A and 3B, respectively, to derive processed frame 40 shown in FIG. 3C, corresponding to processed image 26a in FIG. 2. In such a case, the operator would be provided with a processed image showing human 30, box 34 and object 38.

Of note, it is recognized that when subtracting image data for which an image is present in a subsequent frame but is not in the prior frame, such as object 38 in FIG. 3B, a negative value may result such that the resultant data is not displayable as an image because the corresponding data represents a value below the black value. However, the data for the entire processed image can be scaled so that all data can be presented visibly, or negative values for processed image data displayed as their absolute value. For example, if the processed images are to be displayed on central monitoring station 14 in gray scale in which each pixel is represented b a value of 0-255, the data corresponding to the processed image can be scaled so that all pixels fall within this range or such that a pixel processed to have a negative value because it corresponds to an object that is present in or missing from a subsequent frame can be presented as an absolute value. A more detailed example is provided below. In addition, it is noted that the image data or the resultant processed images can be further processed to reduce noise present in the image. Of note, the scaling, absolute value and noise reduction processes are applicable to any of the image processing methods discussed and described herein, and are not relegated only to the method described in FIG. 2.

Another exemplary method of processing image data and presenting a processed image to an operator using central monitoring station 14 is described with reference to FIG. 4. Assume that the occurrence of an alarm event which results in the capture of images 24a-24e. In accordance with this method, processed images 26a-26d are further processed to create a single processed image 42 representing the summation of data corresponding to images 26a-26d. The resultant composite processed image 42 is displayed to the operator on central monitoring station 14. This arrangement advantageously allows a single image to be presented on central monitoring station14 to quickly allow the operator to determine the presence or absence of a human, object, etc., so that the operator can make a decision as to whether security or law enforcement personnel should be called to the monitored location. For example, although not shown, a human walking across the room would be depicted in processed image 42 as showing the human at different locations in the image, thereby allowing an operator to quickly determine that the human was moving through the monitored location. Based on this situation, the operator can quickly visualize this situation and make a determination as to what further action might be necessary.

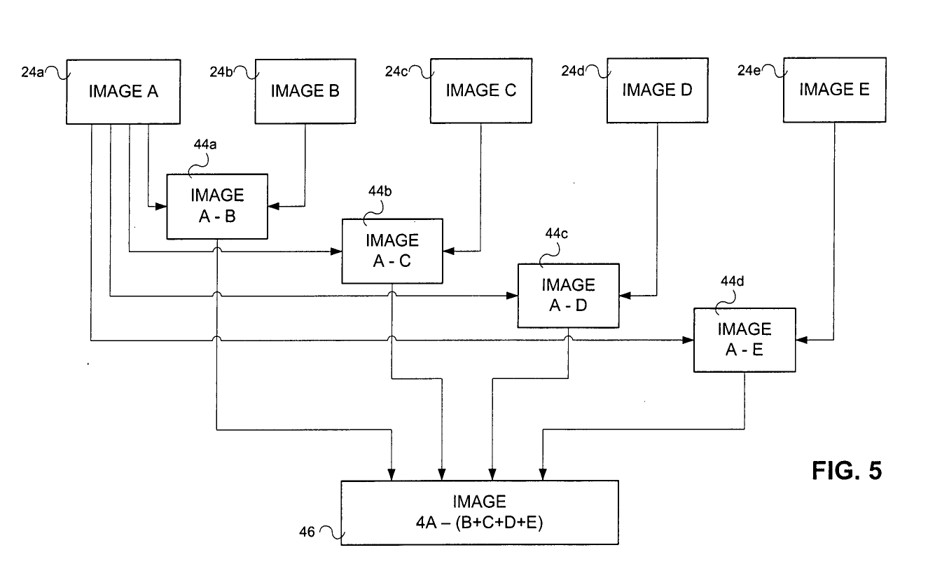

Still another example of a method for creating a single processed image for display on monitoring station 14 based on captured images is described with reference to FIG. 5. In this method, images 24a-24e are processed such that image 24a serves as the starting point, and the data for each subsequent image is subtracted from the image data corresponding to image 24a and results then summed together to form the single image. For example, image data corresponding to images 24a-24e are transmitted by panel 22 to monitoring station 14 and processed to create four sub-images 44a-44d in which each sub-image corresponds to the difference between image 24a and one of images 24b-24e. Data corresponding to each of sub-images 44a-44d are summed together to create processed image 46. The method shown in FIG. 5 essentially scales the starting image by the number of remaining images, image 24a and subtracts from image 24a each of the subsequent images. Pixel value scaling, noise reduction and absolute value processing can also be performed on any of sub-images 44a-44d and/or processed image 46.

It is noted that one or more of images 24a-24e shown in FIGS. 2, 4 and 5 can correspond to images captured pre- or post-alarm event triggering. For example, image 24a can be a pre-event image with the remainder of images 24b-24e captured post-trigger. It is also noted that the present invention is not limited to the capture and processing of five images and that any number of images can be captured and processed. It should therefore be recognized that the use of five captured images is presented merely for ease of explanation and understanding.

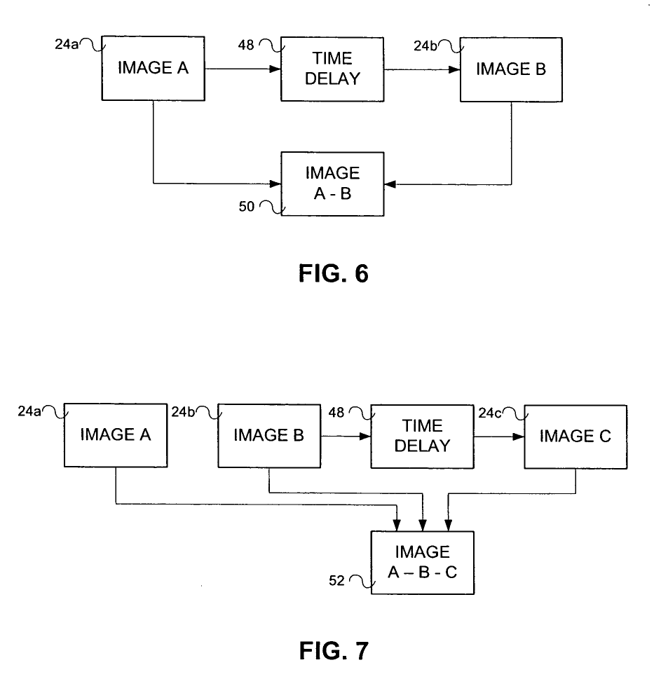

While the methods shown in and described with reference to FIGS. 2, 4 and 5, assume there is a predetermined time interval between the capture of each of images 24a-24e, such is not necessarily the case. For example, as is shown in FIG. 6, time delay 48 can be inserted between the capture of images 24a and 24b so that processed image 50 counts for the additional inclusion of, or substitution by, time delay 48. Time delay 48 can be set such that the image 24a is based on the capture of a triggering event and any event occurring within time delay 48 is subsequently captured as image 24b. For example, a person running through a zone monitored with a motion detector would result in the detector capturing the triggering alarm event resulting in the capture of image 24a, and image 24b is captured before the runner is able to exit the zone. This arrangement advantageously reduces the amount of image data that must be transmitted and processed. As noted above, time delay 48 need not necessarily be provided in addition to the pre-determined time interval between the capture of images 24a and 24b. Rather, time delay 48 can replace the pre-determined time interval, and can be configured on an implementation-by-implementation basis.

FIG. 7 shows still another exemplary method in which a time delay can be used to reduce the amount of image data that is transmitted to and processed by central monitoring station 14. In the method shown in FIG. 7, time delay 48 is inserted between image 24b and 24c in which images 24a-24c are subsequently processed so that image 24a serves as the starting point and the data corresponding to images 24b and 24c are subtracted from image 24a. This arrangement would be useful at a monitored door where the person has not yet entered the video monitored zone. Allowing a time delay between subsequent images time can be provided to allow the person to enter the monitored zone so that a useful assessed image can be created and displayed.

In addition to presenting one or more processed images for visual verification by an operator of an alarm event, the present invention can also be implemented to provide some other indicator when the difference between captured images exceeds a pre-determined threshold. Such an indicator can take the form of a visual indication on the display screen such as a pop-up box, text, or icon, or can be an indicator that is separate from the display screen such as a separate light, sound and the like. In this manner, an operator can be alerted that the changes are significant enough that the operator should pay careful attention to the processed image or images presented for visual verification.

As noted above, image processing can also include processing to remove noise. This can be done, for example, by setting an intensity threshold level in the processing software such that when two image data corresponding to two images are subtracted, only those pixels having a value above a certain pre-determined threshold are displayed. In that same vein, the total number of pixels that have crossed the noise threshold can be expressed as a percent of the total number of image pixels can be provided to the operator on the display screen and used as a figure of merit to determine if there is a reasonable expectation that there was a significant change between the two images being compared. This figure of merit can be saved in a database, such as a database on central monitoring station 14, for archival purposes. This figure of merit can be used as the basis for comparison with the pre-determined threshold in order to determine whether or not the indicator should be enabled and provided to the operator.

As noted above, it is possible that the subtraction operation during processing can yield a negative, and hence, undisplayable pixel, and that one way to address this issue is to scale (shift) the image display values. One way to accomplish this is to scale the pixels using the following method:

C=((A−B)/2)+(R/2)

where C equals the value of the pixel to be displayed, A is the value of pixel A from a first image such as image 24a, B equals the value of a corresponding pixel from the image to be subtracted, such as image 24b, and R is the total range of levels in the two images. If additional contrast is needed, an additional scaling factor can be added as follows:

C=(x(A−B)/2)+(R/2)

where x is a scaling factor greater than 1. If x is such that C>R, then a limiting algorithm can be employed such as: if C>R, then C=R, and if C<0, then C=0. While the contrast level can be established automatically within the programmatic software, processing the images, it is contemplated that the contrast level (x) can be made adjustable by the operator, for example by providing a slider in the display window showing the image, or a separate input area on the display screen, and the like.

The present invention advantageously provides a method, system and central monitoring station which allow image processing for display and visual verification by an operator to be accomplished using a software application that can reside on central monitoring station 14 and which does not require extensive computing power to operate. As such, the programmatic software used to implement the above-described functions does not require a significant amount of computing power because it is not performing extensive digital signal processing (“DSP”). The present invention therefore lends itself to implementation in the form of a small application program that can be resident on and executed by central monitoring station 14. Of course, the software application implementing the above-described functions can also easily be provided in a more centralized server so that all image data arriving from one or more monitored locations can be processed by the server and then transmitted to one or more central monitoring stations 14 for subsequent visual verification.

The present invention can be realized in hardware, software, or a combination of hardware and software. An implementation of the method and system of the present invention can be realized in a centralized fashion in one computing system or in a distributed fashion where different elements are spread across several interconnected computing systems. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A method for verifying an alarm system event, the method comprising:
transmitting image data corresponding to a plurality of images associated with the event;
processing the image data corresponding to the plurality of images to create one or more processed images, the one or more processed images being arranged to allow an operator to visually observe changes in the plurality of images; and
displaying the one or more processed images.

2. The method according to claim 1, wherein one or more processed images are displayed as a series of processed images.

3. The method according to claim 1, wherein a single processed image is displayed, the single processed image being a composite image showing differences between at least two of the plurality of images.

4. The method according to claim 3, further comprising providing an indication to the operator if the differences between the at least two of the plurality of images exceed a predetermined threshold.

5. The method according to claim 2, wherein each of the processed images is a difference between two consecutive images of the plurality of images.

6. The method according to claim 2 wherein the processed images are thumbnail images.

7. The method according to claim 3 wherein the single processed image is the sum of the differences between consecutive images.

8. The method according to claim 3 wherein the single processed image is the sum of the differences between the first image and each of the other of the plurality of images.

9. The method according to claim 1, wherein a first image of the plurality of image corresponds to a pre-event image.

10. The method according to claim 1, wherein a predetermined time interval is provided between acquisition of each of the plurality of images, wherein the method further comprises allowing an additional time delay between acquisition of at least two of the plurality of images.

11. The method according to claim 3, wherein processing the image data includes scaling the data corresponding to the processed image to create a visible displayable processed image.

12. A central monitoring station using image data corresponding to a plurality of images associated with an alarm event to visually verify the alarm event, the central monitoring station comprising:
a central processing unit, the central processing unit processing the image data corresponding to the plurality of images to create one or more processed images, the one or more processed images being arranged to allow an operator to visually observe changes in the plurality of images; and
a display, the display displaying the one or more processed images for visual verification by the operator.

13. The central monitoring station according to claim 12, wherein one or more processed images are displayed as a series of processed images.

14. The central monitoring station according to claim 12, wherein the central processing unit creates a single processed image for display, the single processed image being a composite image showing differences between at least two of the plurality of images.

15. The central monitoring station according to claim 14, further comprising an indicator to alert the operator if the differences between the at least two of the plurality of images exceed a predetermined threshold.

16. The central monitoring station according to claim 13, wherein each of the processed images is a difference between two consecutive images of the plurality of images.

17. The central monitoring station according to claim 13 wherein the processed images are thumbnail images.

18. The central monitoring station according to claim 14 wherein the single processed image is the sum of the differences between consecutive images.

19. The central monitoring station according to claim 14 wherein the single processed image is the sum of the differences between the first image and each of the other of the plurality of images.

20. The central monitoring station according to claim 12, wherein a first image of the plurality of image corresponds to a pre-event image.

21. The central monitoring station according to claim 14, wherein processing the image data includes scaling the data corresponding to the processed image to create a visible displayable processed image.

22. A system for verifying an alarm system event, the system comprising:
a camera, the camera capturing a plurality of images associated with the event: an alarm panel, the alarm panel transmitting image data corresponding to the plurality of images associated with the event; and
a central monitoring station, the central monitoring station having:
a central processing unit, the central processing unit processing the image data corresponding to the plurality of images to create one or more processed images, the one or more processed images being arranged to allow an operator to visually observe changes in the plurality of images; and
a display, the display displaying the one or more processed images.
